(19) United States
(12) Patent Application Publication
(10) Pub. No.: US 2008/0072036 A1
(43) Pub. Date: Mar. 20, 2008

(54) APPARATUS AND METHOD FOR ENHANCING COMPLEXITY IN USER-SELECTED PASSWORD

(76) Inventors: Thomas Rudolf Anzelde, San Jose, CA (US); Todd Michael Eischeid, Cary, NC (US)

Correspondence Address: Kunzler & McKenzie, 8 EAST BROADWAY, SUITE 600, SALT LAKE CITY, UT, 84111, US

(21) Appl. No.: 11/466,185

(22) Filed: Aug. 22, 2006

(51) Int. Cl. H04L 9/00

(52) U.S. Cl. 713/155

(57) ABSTRACT

An apparatus and method to enhance complexity in user-selected passwords. The apparatus includes an input module to receive a sequence of key presses and key releases from a user. A comparator module compares the sequence to a stored sequence of key presses and key releases, where the stored sequence functions as a password to restrict access to a particular resource such as computer files, documents, networks, and/or programs. An access module may grant access to the user if the sequence entered matches the stored sequence of key presses and key releases.

### BACKGROUND OF THE INVENTION

1. Field of the Invention

The invention relates to computer password-based security systems. Specifically, the invention relates to an apparatus and method for enhancing complexity in user-selected passwords.

2. Description of the Related Art

User-selected passwords are a simple security mechanism to restrict access to resources such as computer files, documents, networks, and programs. Indeed, passwords enable a user to uniquely and easily identify himself by entering a predefined string of characters, usually a combination of letters and numbers. Users are encouraged to choose a password that may not be easily guessed or deduced by casual observation. There is a delicate balance between security and convenience, however, and password-based security systems are inevitably vulnerable to breaches of security.

Most password-based security systems require a series of password characters entered independently and in a particular sequence. Such password-based security systems rely solely on this repeatable series of characters to discriminate between authorized and unauthorized users. A password-based security system is thus fallible, as an observant bystander may easily discern the sequence of keystrokes to gain unauthorized access.

Reliable security in password-based security systems generally depends on selection of an inherently complex password, where complexity and security increases with the length, number of character types, and non-intuitive nature of the password. For example, some security systems recommend selection of a password having eight to twelve characters, including at least one letter, number, and non-numeric symbol. Other systems encourage users to select an acronym or other non-word to render the password non-intuitive. Still others require frequent password modification such that a compromised password eventually becomes useless to the unauthorized user.

While such methods may increase the security associated with a user-selected password, an inherently complex and/or lengthy password is often difficult to remember. In an effort to avoid forgetting a modified or complex password, many users resort to writing their password down on a piece of paper. Unfortunately, this practice directly undermines the purpose of the password—security. Even where the security of the system is not compromised in this manner, the difficulty of remembering an inherently complex password or one that must be frequently changed often results in massive amounts of wasted time and resources for the user that forgets his password and must otherwise verify his identity to gain access to a particular password-secured resource.

From the foregoing discussion, it should be apparent that a need exists for an apparatus and method to enhance complexity in user-selected passwords while minimizing an opportunity for unintentional disclosure of such passwords. Beneficially, such an apparatus and method would increase user recall of a user-selected password and stymie the ability of unauthorized users to gain access to password-protected resources. Such an apparatus and method are disclosed and claimed herein.

### SUMMARY OF THE INVENTION

The present invention has been developed in response to the present state of the art, and in particular, in response to the problems and needs in the art that have not yet been met for enhancing complexity in user-selected passwords. Accordingly, the present invention has been developed to provide an apparatus and method for enhancing complexity in user-selected passwords that overcomes many or all of the above-discussed shortcomings in the art.

An apparatus according to the present invention may include an input module, a comparator module and an access module. The input module may receive a password from a user, where the password may include a sequence of key presses and key releases. The comparator module may compare the password to a stored password, and the access module may grant access to the user if the password matches the stored password.

In one embodiment, the sequence includes at least two key presses preceding a key release. In another embodiment, at least two of the key releases are consecutive. In certain embodiments, a key press may comprise a touch on a contact-sensitive key pad or keyboard.

A method of the present invention is also presented for enhancing complexity in user-generated passwords. In one embodiment, the method includes receiving a password from a user. The password, as in the apparatus, may include a sequence of key presses and key releases. The method further includes comparing the password to a stored password and granting access to the user in response to the password matching the stored password.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating various operational modules included in certain embodiments of the present invention; and

FIG. 2 is a schematic block diagram illustrating a method for enhancing complexity in user-selected passwords in accordance with embodiments of the present invention.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

As used in this specification, the term “key” refers to any input device that may be used to enter data into a computer. A key may comprise, for example, a typing key, a numeric key, a function key, a control key, a mouse button, a contact-sensitive key, or any other type of key known to those in the art.

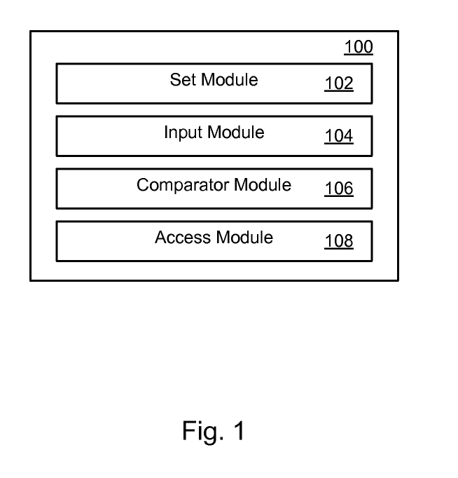

Referring now to FIG. 1, an apparatus 100 to enhance complexity in user-selected passwords in accordance with the present invention may comprise an input module 104, a comparator module 106 and an access module 108. An apparatus 100 may further include a set module 102 to enable a user to set a password to secure access to a particular resource such as computer files, documents, networks, and programs. The set module 102 may prompt a user to set a password to secure access to a particular resource. Similarly, the input module 104 may prompt a user to authenticate a password to gain access to the resource.

The password may include a sequence of key presses and key releases. A user may input the sequence of key presses and key releases by depressing and releasing a resilient key on a keyboard, mouse, or other device known to those in the art. In certain embodiments, the sequence of key presses and key releases may comprise a sequence of touches and releases on a touch pad or other contact-sensitive key pad, keyboard or other device known to those in the art. In other embodiments, the sequence of key presses and releases may comprise other key actions known to those in the art.

A key press in accordance with the present invention may send a scan-code for a corresponding value to an associated computer. A key release in accordance with embodiments of the present invention may send a release code to the computer. If one key is held down while another key is pressed and released, the computer may receive the scan-code for the held key and a scan and release code for the other key. In this manner, the computer may discern an ordered sequence of key presses and key releases in accordance with embodiments of the present invention.

In some embodiments, the password may not be directly associated with key characters. Indeed, two or more key presses may precede a key release. In other embodiments, two or more keys may be consecutively released. Similarly, in some embodiments, two or more keys may be substantially simultaneously pressed and/or released. In this manner, embodiments of the present invention may maximize possible permutations from a finite set of character keys, and thus maximize acceptable passwords. The present invention may also confound an unauthorized user's ability to decode the password by either casual observation or by trial and error.

For example, in some embodiments, a user may select a password derived from the set of character keys “a,” “s,” and “j.” The password, however, may depend on an ordered sequence of key presses and releases involving such character keys, rather than simply the order of characters themselves. In one embodiment, for example, the password may comprise the following ordered sequence: press key “a,” press key “s,” press key “j,” release key “s,” release key “j,” release key “a.”

In other embodiments, a key press may comprise either depression of a substantially resilient key, or contact with the key surface. Key presses may be differentiated according to whether the key is depressed or simply contacted, so as to maximize password possibilities derived from a finite set of keys. In this manner, embodiments of the present invention may encode more than one password constituent depending on the action associated with a single character key. For example, depressing the “a” key may yield a value of “a” while contact with the surface of the “a” key may yield a value of “˜a.”

In another embodiment, a key press may comprise depressing more than one key substantially simultaneously. A substantially simultaneous key press may be encoded as part of a password via standard ASCII characters for easy electronic transmission. For example, a key press comprising substantially simultaneous depression of the “c,” “a,” and “t” keys may be encoded as “[cat].”

Passwords dependent on a sequence of key presses and releases as disclosed above may be intuitive to players of wind and other musical instruments. Indeed, wind instrument technique is based on independently operable keys that may be pressed and/or released in various combinations to create a range of notes much greater than the number of keys from which they are derived. Similarly, the present invention increases possible passwords available from a finite set of character keys.

The present invention also adds a layer of complexity to an otherwise simple, intuitive password. Indeed, while the particular ordered sequence of key presses and key releases may be easily remembered and entered by an authorized user, this added layer of complexity may stymie attempts by an unauthorized user to decode the password.

A comparator module 106 may compare the sequence of key presses and releases received by the input module 104 to the sequence of key presses and releases stored as the password by the set module 102. In some embodiments, the comparator module 106 may compare each key press and release of the set password to each key press and release of the input password to determine, in series, whether the input password matches the set password. In other embodiments, the comparator module 106 may compare the ordered sequence string of key presses and releases corresponding to the set password to the ordered sequence string of key presses and releases corresponding to the input password to determine a match. In either case, an access module 108 may grant access to a user in response to the input password matching the set password.

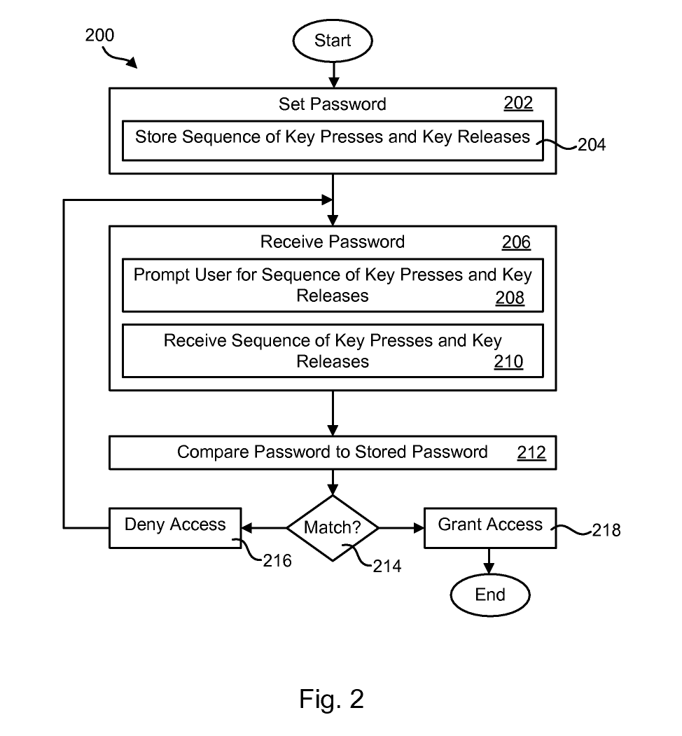

Referring now to FIG. 2, a method 200 to enhance complexity in a user-selected password in accordance with embodiments may include setting 202 a password to restrict access to a particular resource. As in the apparatus 100, the password may comprise an ordered sequence of key presses and key releases independent of the character associated with any particular key. Setting 202 the password may further include storing 204 the password to secure resource access.

As in the apparatus 100, the sequence of key presses and key releases may comprise touches on a touch pad or other contact-sensitive key pad or keyboard known to those in the art. The password may not be directly associated with key characters. In some embodiments, two or more key presses may precede a key release. In other embodiments, two or more keys may be consecutively released. Also, in some embodiments, two or more keys may be substantially simultaneously pressed and/or released.

The method 200 may further comprise receiving 206 a password from a user. In some embodiments, receiving 206 a password may include prompting 208 a user for the password and receiving 210 a sequence of key presses and releases in response to the prompt. The method 200 may then include comparing 212 the received password to a stored password to determine whether the received password matches 212 the stored password. As in the apparatus 100, the comparing 212 step may compare each key press and release of the received sequence in series, or as a string of key presses and releases. If the received password fails to match the stored password, the method may deny 216 access to the user and return to the receive 206 password step. If the received password positively matches the stored password, the method may grant 214 user access to the secured resource.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to enhance complexity in user-generated passwords, comprising:
an input module to receive a password from a user, the password comprising a sequence of key presses and key releases;
a comparator module to compare the password to a stored password; and
an access module to grant access to the user in response to the password matching the stored password.

2. The apparatus of claim 1, wherein the sequence comprises at least two key presses preceding a key release.

3. The apparatus of claim 1, wherein at least two of the key releases are consecutive.

4. A method to enhance complexity in user-generated passwords, comprising:
receiving a password from a user, the password comprising a sequence of key presses and key releases;
comparing the password to a stored password; and
granting access to the user in response to the password matching the stored password.

5. The method of claim 4, wherein the sequence comprises at least two key presses preceding a key release.

6. The method of claim 4, wherein at least two of the key releases are consecutive.
